(19) United States
(12) Patent Application Publication
(10) Pub. No.: US 2021/0224942 A1
(43) Pub. Date: Jul. 22, 2021

(54) VEHICLE RIDE-SHARING ASSIST SYSTEM

(71) Applicant: HONDA MOTOR CO., LTD., Minato-ku, Tokyo (JP)

(72) Inventors: Kenichi KOBAYASHI, Saitama (JP); Isao UEMATSU, Saitama (JP)

(21) Appl. No.: 15/734,281

(22) PCT Filed: May 27, 2019
(86) PCT No.: PCT/JP2019/020957

§ 371 Date: Dec. 2, 2020

(30) Foreign Application Priority Data
Jun. 8, 2018 (JP) 2018-110127

(51) Int. Cl. G06Q 50/30; G06Q 10/06; G06Q 30/02; G01C 21/34

(52) U.S. Cl. CPC G06Q 50/30; G01C 21/3438; G06Q 30/0226; G06Q 10/06312

(57) ABSTRACT

To promote utilization of ride-sharing, a vehicle ride-sharing assist system (1) utilized by a group including a plurality of members includes: a ride-sharing operation managing unit (22) configured to accept ride-sharing applications from the members for each prescribed period, to determine an operation schedule of at least one vehicle utilized for the ride-sharing, and to notify the operation schedule to the members that have made the ride-sharing applications; a data acquiring unit (23) configured to acquire utilization data of each member that has performed the ride-sharing of the vehicle, the utilization data including item values respectively assigned to a plurality of items related to operation of the ride-sharing; and a giving unit (25) configured to convert each item value to a converted value for each member that has performed the ride-sharing in each prescribed period and to give each member a sum of the converted value as points.

### TECHNICAL FIELD

The present invention relates to a vehicle ride-sharing assist system for providing users with a ride-sharing service.

### BACKGROUND ART

A vehicle ride-sharing assist system (a ride-sharing service system) know in the art assists in ride-sharing performed by a driver who plans to move by automobile and a passenger who desires to board an automobile of others so as to move to a destination (for example, Patent Document 1). The operation number of automobiles can be reduced by performing the ride-sharing, so that energy can be saved, CO₂ emissions can be reduced, and traffic congestion can be mitigated.

### PRIOR ART DOCUMENT(S)

### Patent Document(s)

Patent Document 1: JP2002-140399A

### SUMMARY OF THE INVENTION

### Task to be Accomplished by the Invention

However, it is difficult for the user to realize such an effect, and thus the user may put a priority on convenience and may not utilize the ride-sharing. As a result, there is a problem that utilization of the ride-sharing cannot be promoted.

In view of such a background, an object of the present invention is to promote utilization of the ride-sharing.

### Means for Accomplishing the Task

To achieve such an object, one embodiment of the present invention provides a vehicle ride-sharing assist system (1) utilized by a group including a plurality of members, including: a ride-sharing operation managing unit (22) configured to accept ride-sharing applications from the members for each prescribed period, to determine an operation schedule of at least one vehicle utilized for ride-sharing, and to notify the operation schedule to the members that have made the ride-sharing applications; a data acquiring unit (23) configured to acquire utilization data of each member that has performed the ride-sharing of the vehicle, the utilization data including item values respectively assigned to a plurality of items related to operation of the ride-sharing; and a giving unit (25) configured to convert each item value to a converted value for each prescribed period and each member that has performed the ride-sharing in each prescribed period and to give each member a sum of the converted value as points.

According to this arrangement, the points are given to each member who has utilized the ride-sharing. By giving the points, it is possible to give the members of the group an incentive to utilize the ride-sharing, and thus to promote utilization of the ride-sharing. Further, by giving the points based on the plurality of item values, it is possible to adjust the contribution degree of each item to the points given to each member. Accordingly, the administrator that operates the system can easily gain the desired effect.

In the above arrangement, preferably, the vehicle ride-sharing assist system further includes a coefficient storing unit (26) configured to store a coefficient corresponding to each item, wherein the converted value is converted by multiplying each item value by the coefficient corresponding to each item value.

According to this arrangement, each item value can be easily converted into the points. Further, the points are given in proportion to each item value, so that the feeling of unfairness about the given points can be reduced.

In the above arrangement, preferably, the vehicle ride-sharing assist system according to claim 2, further includes: one evaluation value acquiring unit (24) configured to acquire an evaluation value for all the ride-sharing performed by the group in each prescribed period; and an increase processing unit (27) configured to receive an increase request and an increase value, the increase request instructing an increase in a total of the points given to the members of the group, wherein when receiving the increase request, the increase processing unit changes the coefficient of each item, acquires the evaluation value in the ride-sharing performed after the coefficient of each item is changed and thus acquires an improvement amount of the evaluation value per unit of the converted value of each item, extracts one of the items with a largest improvement amount per unit of the converted value as a main item, and executes increase processing to allocate a largest increase value to the main item.

According to this arrangement, the improvement amount of the evaluation value per unit point can be acquired for each item, so that the item with the largest improvement amount of the evaluation value (namely, the main item) can be evaluated appropriately when a certain number of points are given. Accordingly, the points can be utilized more effectively in order to improve the evaluation value.

In the above arrangement, preferably, in the increase processing, the increase processing unit acquires one value by dividing the increase value by a sum of the item value of the main item for all the members that have performed the ride-sharing, and adds the one value to the coefficient corresponding to the main item.

According to this arrangement, by changing the coefficient of the main item, the evaluation value can be improved effectively and the increase number of points given to the group can be substantially identical to the scheduled number.

In the above arrangement, preferably, the data acquiring unit is configured to acquire driver information including information as to whether each member has served as a driver in the ride-sharing, and in a case where one member has served as the driver in the ride-sharing, the giving unit gives the one member more points than in a case where the one member has not served as the driver.

According to this arrangement, by giving more points to the driver than the passenger, so that the number of members who desire to be drivers can be increased. Accordingly, a trouble caused by the shortage of drivers can be suppressed.

### Effect of the Invention

Thus, according to the above arrangements, it is possible to promote utilization of the ride-sharing.

### BRIEF DESCRIPTION OF THE DRAWING(S)

FIG. 1 is a block diagram of a vehicle ride-sharing assist system according to an embodiment;

FIG. 2 is an explanatory diagram for explaining how to acquire data entered into a utilization data table;

FIG. 3 is an explanatory diagram illustrating the data entered into the utilization data table;

FIG. 4 is an explanatory diagram illustrating data entered into a coefficient table;

FIG. 5 is a flowchart showing a flow of increase processing;

FIG. 6 is a flowchart of analysis pretreatment;

FIG. 7 is a flowchart of analysis processing;

FIG. 8 is a flowchart of coefficient increase processing;

FIG. 9 is a sequence diagram showing a flow of a ride-sharing service; and

FIG. 10 is a sequence diagram showing a flow of the ride-sharing service when points are increased.

### MODE(S) FOR CARRYING OUT THE INVENTION

In the following, with reference to the drawings, an embodiment of a vehicle ride-sharing assist system will be described. The vehicle ride-sharing assist system according to the embodiment is operated by an administrator who belongs to a specific group (a company, a government office, a sports club, a nursing home, a shopping center, or the like), and provides a ride-sharing service of the vehicle to the members (users) who belong to the specific group for each prescribed period (hereinafter referred to as “term”).

The ride-sharing service described herein includes steps of: receiving desired ride-sharing conditions (for example, a departure place, a destination, a departure time, and an arrival time) desired by each user; determining an optimal combination of the users who perform ride-sharing, an optimal vehicle, and an optimal travel route (for example, a route that can minimize traffic congestion) based on the received desired ride-sharing conditions; and notifying each user of these determined matters.

Further, each time the ride-sharing is performed, the vehicle ride-sharing assist system gives points to each user who has performed the ride-sharing. The points may be cashable, or may be usable for purchasing goods, maintaining a vehicle, utilizing a parking lot, or making preferential reservations for various events. Further, the points may be exchangeable for prizes such as on-vehicle items or sundries, or an award may be given to each user in the group depending on the points.

In the following example, the vehicle ride-sharing assist system provides the ride-sharing service to plural employees of one company during commuting hours from 6:00 to 9:00 in the morning on weekdays (hereinafter referred to as “operation period”). Regarding the vehicle ride-sharing assist system, each term is determined as a period to execute processing for assisting in the ride-sharing performed in the operation period. A term identification number is set for each term, and each term is set to a period from 11:00 on the day before the operation period to 10:30 in the morning on the day of the operation period. An acceptance start time (12:00 on the day before the operation period), an acceptance end time (20:00 on the day before the operation period), a ride-sharing start time (6:00 in the morning on the day of the operation period), a ride-sharing end time (9:00 in the morning on the day of the operation period), an increase processing time (9:30 in the morning on the day of the operation period), a point giving time (10:00 in the morning on the day of the operation period) are set for each term. Further, in the ride-sharing according to the present embodiment, it is assumed that one user who utilizes a shared vehicle when going home drives the shared vehicle in the entire travel route, and all the users head to one workplace as an arrival place.

The company that utilizes the vehicle ride-sharing assist system owns plural shared vehicles to be utilized for the ride-sharing service. The shared vehicles are registered in the vehicle ride-sharing assist system. In the vehicle ride-sharing assist system, user identification numbers are set for all the users, and vehicle identification numbers are set for all the shared vehicles and all the provided vehicles.

(The Structure of the Vehicle Ride-Sharing Assist System)

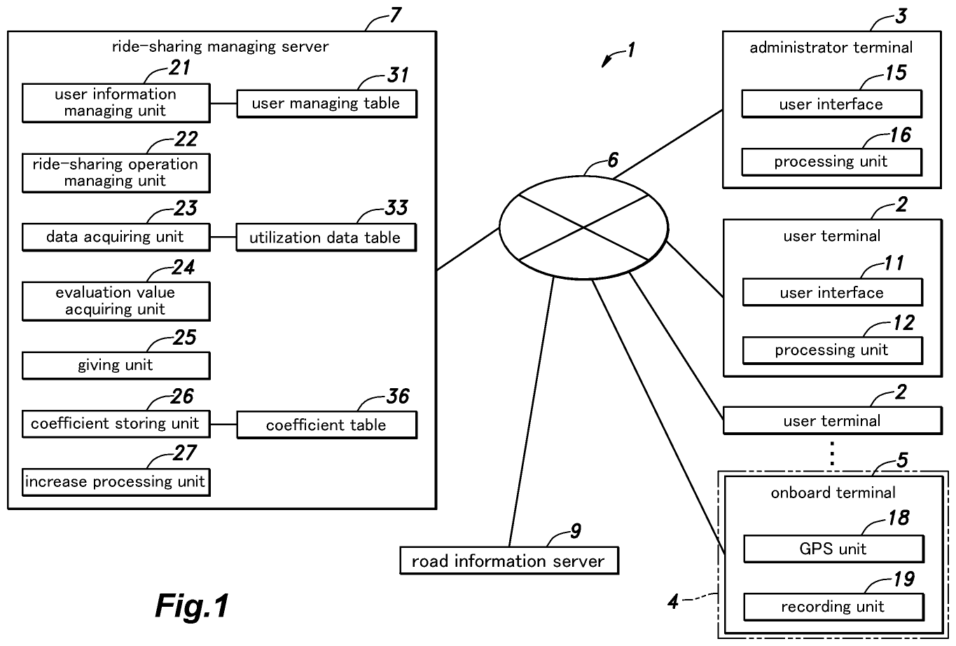

As shown in FIG. 1, the vehicle ride-sharing assist system 1 includes plural user terminals 2, one administrator terminal 3, at least one onboard terminal 5 mounted on each shared vehicle 4, and a ride-sharing managing server 7 connected to each user terminal 2, the administrator terminal 3 and the onboard terminal 5 via a network 6. Each user terminal 2 is configured to be carried by each user. The administrator terminal 3 is used by the administrator who belongs to the company that utilizes the vehicle ride-sharing assist system 1. The administrator administers the vehicle ride-sharing assist system 1 by getting access to the ride-sharing managing server 7 by using the administrator terminal 3. The ride-sharing managing server 7 and the administrator terminal 3 are provided in the building of the company that operates the vehicle ride-sharing assist system 1. The network 6 is, for example, the Internet.

The ride-sharing managing server 7 is connected to a road information server 9 via the network 6 such that the ride-sharing managing server 7 can communicate with the road information server 9. The road information server 9 is configured to hold road information about an area where the ride-sharing is performed and to search for a travel route that connects prescribed points in response to a request from the outside. Further, the road information server 9 may be configured to hold past data and real-time data of congestion information and to search for an appropriate travel route based on the road information and the congestion information.

Each user terminal 2 includes: a user interface 11 configured to display an input screen and a message and to receive an input by each user; and a processing unit 12 configured to process an input from the user interface 11. For example, each user terminal 2 consists of a smartphone, a mobile phone, or the like. The processing unit 12 executes a prescribed application, thereby causing the user interface 11 to receive an input of ride-sharing application information by the user and transmitting the ride-sharing application information to the ride-sharing managing server 7. The ride-sharing application information may include the departure place, the departure time, and the arrival time desired by each user. Further, in a case where one user utilizes the shared vehicle 4 when going home, the ride-sharing application information may include the information about the above shared vehicle 4. On receiving ride-sharing schedule information from the ride-sharing managing server 7, each user terminal 2 causes the user interface 11 to display the ride-sharing schedule information together with a prescribed message. The ride-sharing schedule information may include the name of the driver, the information about the vehicle utilized for the ride-sharing, the travel route, the scheduled departure time, the name of the passenger, the scheduled ride-sharing place, and the scheduled ride-sharing time. Further, on receiving point giving information, each user terminal 2 causes the user interface 11 to display a message indicating the number of points newly given to each user.

The administrator terminal 3 includes: a user interface 15 configured to display an input screen and a message and to receive an input by each user; and a processing unit 16 configured to process an input from the user interface 15. For example, the administrator terminal 3 consists of a desktop PC, a notebook PC, or a tablet PC. When an increase value ΔI of the total points given to all the users is input from the user interface 15, the processing unit 16 transmits an increase request (point increase request) including the increase value ΔI to the ride-sharing managing server 7.

The onboard terminal 5 is mounted on each shared vehicle 4, and is a small computer provided with a central processing unit, a memory, and the like. The onboard terminal 5 includes: a GPS unit 18 configured to acquire positional information of the vehicle; and a recording unit 19 configured to record a travel log, which is a combination of the positional information of the vehicle acquired by the GPS unit 18 and the time. Upon receiving a record start request from the ride-sharing managing server 7, the recording unit 19 starts a recording of the travel log. Upon receiving a record transmission request from the ride-sharing managing server 7, the recording unit 19 ends the recording of the travel log and transmits the travel log to the ride-sharing managing server 7.

The ride-sharing managing server 7 is a computer including a central processing unit, a memory, a hard disk, and the like. The ride-sharing managing server 7 includes: a user information managing unit 21 configured to hold information about each user; a ride-sharing operation managing unit 22 configured to manage operation of the ride-sharing performed in each term; a data acquiring unit 23 configured to acquire utilization data such as a riding distance of each user in the performed ride-sharing; an evaluation value acquiring unit 24 configured to acquire one evaluation value for all the ride-sharing performed in each term; a giving unit 25 configured to give the points to each user; a coefficient storing unit 26 configured to store coefficients used for giving the points to each user; and an increase processing unit 27 configured to execute processing for increasing the points given to each user.

The user information managing unit 21 stores user information (information related to each user) in a user managing table 31. The user information includes the user identification number, the name of each user, and the number of points each user holds. The user information may further include the driving skill level of each user, the past information as the driver, the information about the driver's license, a medication state, a health state, and the like.

The ride-sharing operation managing unit 22 processes the ride-sharing application information transmitted from each user terminal 2 from the acceptance start time to the acceptance end time, and stores the number of ride-sharing users N (the number of users who have made the ride-sharing applications). Next, the ride-sharing operation managing unit 22 determines the driver from the users who have made the ride-sharing applications, creates plural ride-sharing groups, and determines an operation schedule by referring to the outside road information server 9 which holds map information. The operation schedule includes the travel route of the vehicle of each ride-sharing group and the user identification number (driver information) of the driver of each ride-sharing group. At this time, the ride-sharing operation managing unit 22 may determine each ride-sharing group and the operation schedule of the ride-sharing such that traffic congestion can be minimized. The ride-sharing operation managing unit 22 creates the ride-sharing schedule information (information each user requires to perform the ride-sharing) based on the determined operation schedule, and notifies each user of the ride-sharing schedule information via the user terminal 2. The ride-sharing schedule information may include the scheduled departure place, the scheduled departure time, the scheduled arrival time, the vehicle identification number and the travel route of the scheduled vehicle, the user identification number of the driver, and the user identification number of the user other than the driver (hereinafter referred to as “passenger”) who rides the scheduled vehicle. The ride-sharing operation managing unit 22 notifies the ride-sharing schedule information to all the users who have made the ride-sharing application, and holds the operation schedule until the next term starts.

The data acquiring unit 23 transmits the record start request to each onboard terminal 5 at the ride-sharing start time. After that, the data acquiring unit 23 transmits the record transmission request to each onboard terminal 5 and acquires the travel log from the recording unit 19 of each onboard terminal 5 at the ride-sharing end time. Next, the data acquiring unit 23 extracts the user identification numbers of the driver and the passenger of each shared vehicle 4 by referring to the operation schedule held in the ride-sharing operation managing unit 22.

Next, the data acquiring unit 23 acquires a boarding position (a position where the driver and the passenger have boarded the vehicle) and a ride-sharing end position based on the travel log. After that, the data acquiring unit 23 acquires a riding distance and a sharing distance for each of the driver and the passenger. The riding distance is a distance the vehicle travels while each user is riding the vehicle. The sharing distance is a distance the vehicle travels while each user is sharing the vehicle with other users. Further, the data acquiring unit 23 acquires a direct distance for each of the driver and the passenger by referring to the road information server 9. The direct distance is an estimated shortest travel distance of the vehicle from the boarding position to the ride-sharing end position. Next, the data acquiring unit 23 acquires a required pickup distance for each of the driver and the passenger by subtracting the direct distance from the riding distance. The required pickup distance corresponds to a distance the vehicle travels superfluously while each user is riding the vehicle as compared with a case where each user directly heads from the boarding position to the destination.

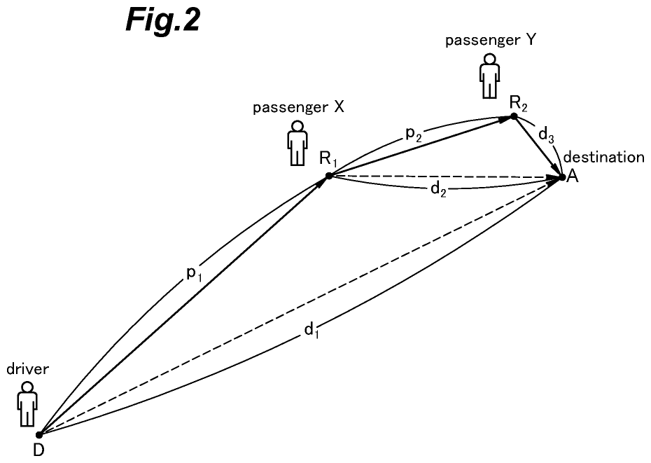

In an example shown in FIG. 2, a driver with a user identification number 0123 boards a shared vehicle at point D, a passenger X with a user identification number 0234 boards the shared vehicle at point R₁, a passenger Y with a user identification number 0345 boards the shared vehicle at point R₂, and the ride-sharing is performed to a point A (destination). When the ride-sharing is performed, the travel distance of the shared vehicle between the point D and the point R₁ is p₁ (10 km), the travel distance of the shared vehicle between the point R₁ and the point R₂ is p₂ (5 km), the travel distance of the shared vehicle between the point R₂ and the point A is d₃ (2 km), the direct distance between the point D and the point A is d₁ (15 km), and the direct distance between the point R₁ and the point A is d₂ (6 km). At this time, the riding distance of the driver is pᵢ+p₂+d₃, the riding distance of the passenger X is p₂+d₃, and the riding distance of the passenger Y is d₃. At this time, the sharing distance of the driver is p₂+d₃, the sharing distance of the passenger X is p₂+d₃, and the sharing distance of the passenger Y is d₃. The required pickup distance of the driver is pᵢ+p₂+d₃-d₁, the required pickup distance of the passenger X is p₂+d₃-d₂, and the required pickup distance of the passenger Y is 0.

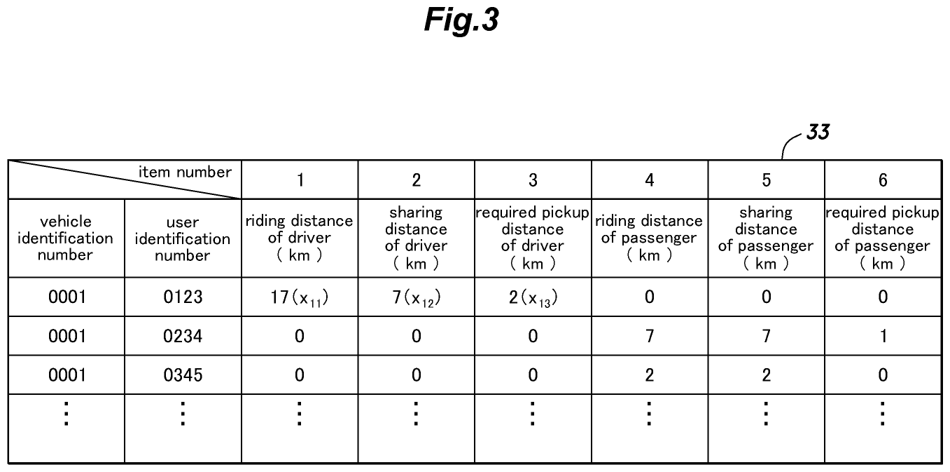

The data acquiring unit 23 stores a utilization data table 33 shown in FIG. 3. Item values respectively assigned to plural items are written to the utilization data table 33. The items include the vehicle identification number, the user identification number, the riding distance of the driver, the sharing distance of the driver, the required pickup distance of the driver, the riding distance of the passenger, the sharing distance of the passenger, and the required pickup distance of the passenger.

Item number i starting from 1 is sequentially allocated to each item of the utilization data table 33 except for the vehicle identification number and the user identification number. In the following, each item will be referred to as “the i-th item” by using the item number i, if necessary. In the present embodiment, as shown in FIG. 3, the item number of the riding distance of the driver is “1”, and the riding distance of the driver is set to the first item. Further, the sharing distance of the driver is set to the second item, the required pickup distance of the driver is set to the third item, the riding distance of the passenger is set to the fourth item, the sharing distance of the passenger is set to the fifth item, and the required pickup distance of the passenger is set to the sixth item. The data acquiring unit 23 acquires the riding distance, the sharing distance, and the required pickup distance of each user. In a case where the user is the driver, the data acquiring unit 23 writes the riding distance, the sharing distance, and the required pickup distance of this user to the utilization data table 33 as the riding distance, the sharing distance, and the required pickup distance of the driver, respectively. In a case where the user is not the driver, the data acquiring unit 23 writes the riding distance, the sharing distance, and the required pickup distance of this user to the utilization data table 33 as the riding distance, the sharing distance, and the required pickup distance of the passenger, respectively. In the following, the maximum value of the item number will be referred to as “the number of analyzed items M” (six in the present embodiment), and the user corresponding to the user identification number written in the j-th space from the top of the utilization data table 33 will be referred to as “the user j”. Further, the item value of the i-th item of the user j will be referred to as “xⱼᵢ”. In FIG. 3, the user with the user identification number 0123 (driver in FIG. 2) corresponds to user 1, and x₁₂ is 7 (=p₂+d₃).

When the ride-sharing end time arrives, the evaluation value acquiring unit 24 acquires a utilization rate ρ as one evaluation value for all the ride-sharing performed by the group. The utilization rate ρ may be calculated by dividing the number of ride-sharing users N in the corresponding term by the total number of users who belong to the group.

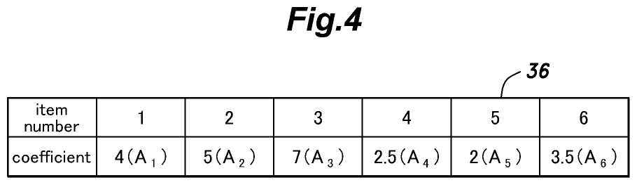

The coefficient storing unit 26 stores a coefficient table 36 shown in FIG. 4. The coefficients A₁ to A_{M} each corresponding to the first to M-th items are recorded in the coefficient table 36. Each coefficient A₁ to A_{M} is a numerical value preset by the administrator. In the present embodiment, a coefficient A₁ for the riding distance of the driver, a coefficient A₂ for the sharing distance of the driver, a coefficient A₃ for the required pickup distance of the driver, a coefficient A₄ for the riding distance of the passenger, a coefficient A₅ for the sharing distance of the passenger, and a coefficient A₆ for the required pickup distance of the passenger are recorded in the coefficient table 36. The coefficients A₁ to A₃ for the driver are set to be larger than the corresponding coefficients A₄ to A₆ for the passenger, respectively (A₁>A₄, A₂>A₅, and A₃>A₆).

When the point giving time arrives, the giving unit 25 converts item values to converted values by referring to the utilization data table 33 and the coefficient table 36. Each converted value is acquired by converting the item value of each item (the riding distance of the driver, the sharing distance of the driver, the required pickup distance of the driver, the riding distance of the passenger, the sharing distance of the passenger, and the required pickup distance of the passenger) into the points of each user. Each converted value is converted by multiplying each item value by the coefficient corresponding to each item value of the corresponding term. More specifically, for example, in a case where the item value of the first item (the riding distance of the driver) of the user j is xⱼ₁ and the coefficient of the first item (the riding distance of the driver) of the corresponding term is A₁, the converted value is A₁xⱼ₁. After calculating the converted value of each item value, the giving unit 25 calculates the number of points to be newly given to each user by acquiring the sum of the converted value of each item. More specifically, the points given to the user j (hereinafter referred to as “given value”) is calculated by the following equation.

$${I}_{j} = {\sum }_{i = 1}^{M} {A}_{i} {x}_{ji} \qquad [ Equation 1 ]$$

Upon completing calculating the given value for all the users who have utilized the ride-sharing in the term, the giving unit 25 refers to the user managing table 31, adds the corresponding given value to a point value of each user who has utilized the ride-sharing, and thus updates the point value. Accordingly, the points are newly given to the user who has utilized the ride-sharing. Upon completing giving points, the giving unit 25 transmits the point giving information to the user terminal 2 of the user who has utilized the ride-sharing. The point giving information includes the given value for each user who carries the user terminal 2. Upon receiving the point giving information, the processing unit 12 of the user terminal 2 causes the user interface 11 to display a prescribed message including the given value. Accordingly, each user who has utilized the ride-sharing is notified of the number of points newly given to each user.

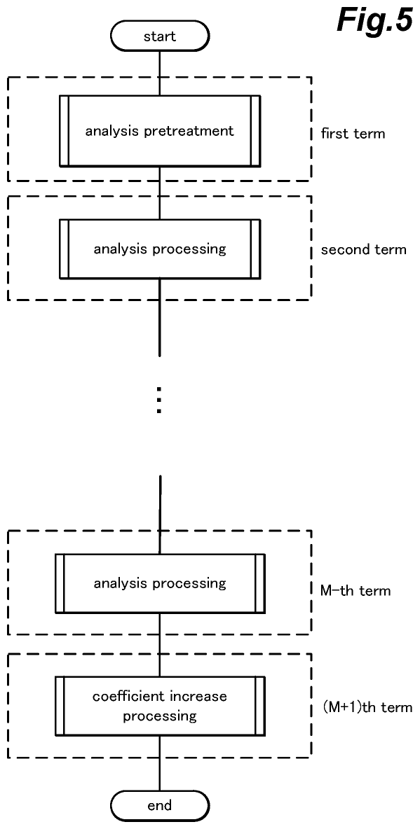

Upon receiving the increase request (point increase request) including the increase value ΔI from the administrator terminal 3 via the network 6, the increase processing unit 27 executes increase processing. As shown in FIG. 5, the increase processing includes analysis pretreatment executed in the first term after receiving the increase request, analysis processing executed in each term from the second term to the M-th term, and coefficient increase processing executed in the (M+1)th term. The analysis pretreatment, the analysis processing, and the coefficient increase processing are executed at the increase processing time of each term. In the following, the details of the analysis pretreatment, the analysis processing, and the coefficient increase processing will be described.

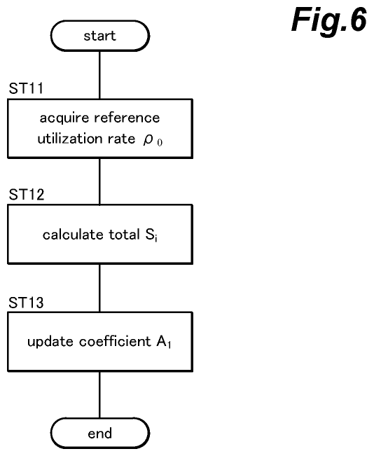

As shown in FIG. 6, in the first step ST11 of the analysis pretreatment, the increase processing unit 27 acquires the utilization rate ρ from the evaluation value acquiring unit 24, and stores the acquired utilization rate ρ as a reference utilization rate ρ₀. Next, in step ST12, the increase processing unit 27 calculates the total of the item values of each item for all the users by using the utilization data table 33. The total Sᵢ (i=a number from 1 to M) of the item values of the i-th item is calculated by the following equation.

$${S}_{i} = {\sum }_{j = 1}^{N} {x}_{ji} \qquad [ Equation 2 ]$$

Next, in step ST13, the increase processing unit 27 increases the coefficient A₁ in the coefficient table 36 by a prescribed value δA (hereinafter referred to as “coefficient changing amount”) so as to update the coefficient A₁ in the coefficient table 36 to A₁+δA, and completes the analysis pretreatment. The analysis pretreatment is completed before the point giving time.

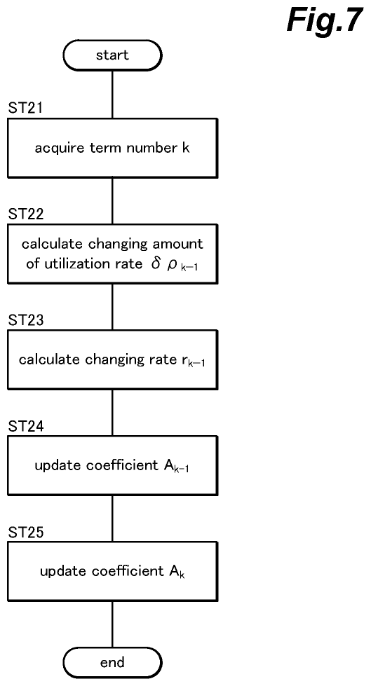

When the increase processing time arrives in the analysis processing, as shown in FIG. 7, the increase processing unit 27 executes the first step ST21 of the analysis processing. In step ST21, the increase processing unit 27 determines which term the current term corresponds to and thus acquires the number k of the current term (2≤k≤M; hereinafter referred to as “term number”). For example, in a case where the increase processing unit 27 executes step ST21 in the second term, the term number k is “2”. In step ST22 after step ST21, the increase processing unit 27 acquires the utilization rate ρ from the evaluation value acquiring unit 24, calculates the difference between the acquired utilization rate ρ and the reference utilization rate ρ₀, and stores the calculated difference as a changing amount of the utilization rate δρₖ₋₁. Then, in step ST23, the increase processing unit 27 acquires one value by dividing the changing amount of the utilization rate δρₖ₋₁ by the total Sₖ₋₁ of the item values of the (k−1)th item and the coefficient changing amount δA, and stores the above one value as a changing rate rₖ₋₁ of the (k−1)th item. The changing rate rₖ₋₁ of the (k−1)th item is calculated by the following equation.

$${r}_{k - 1} = \frac{δ {p}_{k - 1}}{{S}_{k - 1} δA} \qquad [ Equation 3 ]$$

Sₖ₋₁δA is substantially identical to an increase in the points given to the group in the ride-sharing at a time when the coefficient Aₖ₋₁ is increased by δA. Accordingly, the changing rate rₖ₋₁ corresponds to an improvement amount of the utilization rate at a time when the points corresponding to the (k−1)th item are increased by one unit.

Next, in step ST24, the increase processing unit 27 reduces the coefficient Aₖ₋₁ in the coefficient table 36 by δA. Then, in step ST25, the increase processing unit 27 adds δA to the coefficient Aₖ corresponding to the k-th item and thus updates Aₖ to Aₖ+δA, and completes the analysis processing. The analysis processing is completed before the point giving time. After that, the giving unit 25 gives the points to each user according to the updated coefficient table 36.

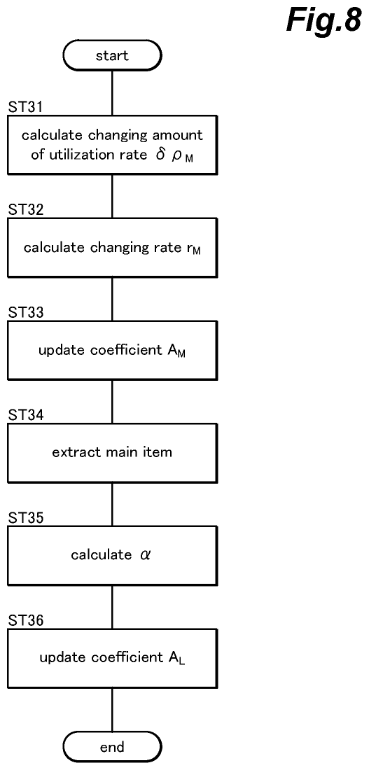

As shown in FIG. 8, in the first step ST31 of the coefficient increase processing, the increase processing unit 27 acquires the utilization rate ρ from the evaluation value acquiring unit 24, and stores the difference between the acquired utilization rate ρ and the reference utilization rate ρ₀ as the changing amount of the utilization rate δρ_{M}. Then, in step ST32, the increase processing unit 27 acquires one value by dividing the changing amount of the utilization rate δρ_{M} by the coefficient changing amount δA and the total S_{M} of the item values of the M-th item, and stores the above one value as a changing rate r_{M}. Next, in step ST33, the increase processing unit 27 reduces the coefficient A_{M} corresponding to the M-th item by δA. Next, in step ST34, the increase processing unit 27 extracts the item with the largest changing rate of all the items as a main item. In the following, it is assumed that the main item is the L-th item. In step ST35, the increase processing unit 27 calculates a numerical value α by using the following equation.

α=ΔI/S_{L} [Equation 4]

Next, in step ST36, the increase processing unit 27 adds the numerical value α to the coefficient A_{L} of the L-th item in the coefficient table 36 so as to update the coefficient A_{L}, and completes the coefficient increase processing. When the coefficient increase processing is completed, the increase processing ends. The coefficient increase processing is completed before the point giving time, and the giving unit 25 gives the points to each user according to the updated coefficient table 36. At this time, the total of the item values of the L-th item for all the users in the first term is S_{L}, and thus the points given to the group in the (M+1)th term substantially increase by ΔI (=α×S_{L}) as compared with the points given to the group in the first term.

Further, in the present embodiment, the increase processing unit 27 is configured to notify the administrator of the item number (L) of the main item (the item with the largest changing rate), after the increase processing and before the point giving time in the (M+1)th term.

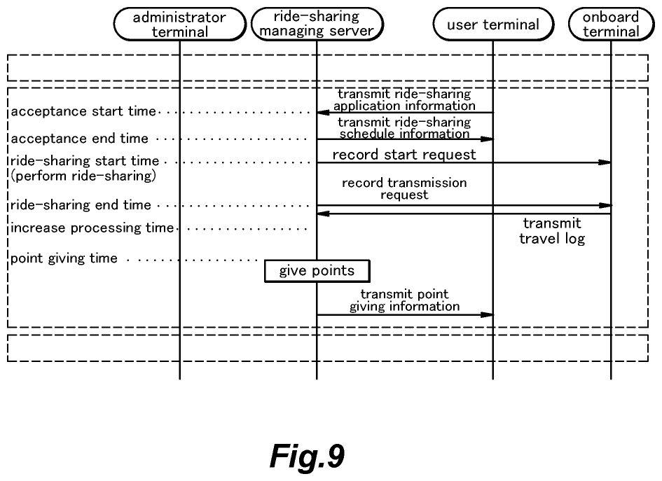

Next, the operation and the effect of the vehicle ride-sharing assist system 1 will be described. As shown in FIG. 9, the ride-sharing application information is transmitted from the user terminal 2 of the user who desires to utilize the ride-sharing to the ride-sharing managing server 7 between the acceptance start time and the acceptance end time. When the acceptance end time arrives, the ride-sharing operation managing unit 22 creates the operation schedule based on the ride-sharing application information received between the acceptance start time and the acceptance end time, and transmits the ride-sharing schedule information to the user terminal 2 of each user.

When the ride-sharing start time arrives, the data acquiring unit 23 transmits the record start request to the recording unit 19 of the onboard terminal 5. Upon receiving the record start request, the recording unit 19 of the onboard terminal 5 starts a recording of the travel log. Further, each user performs the ride-sharing according to the ride-sharing schedule information between the ride-sharing start time and the ride-sharing end time. When the ride-sharing start time arrives, the data acquiring unit 23 transmits the record transmission request to the recording unit 19 of the onboard terminal 5. Upon receiving the record transmission request, the recording unit 19 of the onboard terminal 5 transmits the travel log to the data acquiring unit 23. Upon receiving the travel log, the data acquiring unit 23 calculates the riding distance of the driver, the sharing distance of the driver, the required pickup distance of the driver, the riding distance of the passenger, the sharing distance of the passenger, and the required pickup distance of the passenger for each user based on the travel log and the operation schedule held by the ride-sharing operation managing unit 22, and writes these distances to the utilization data table 33 together with the vehicle identification number and the user identification number. When the point giving time arrives, the giving unit 25 calculates the given value for all the users who have utilized the ride-sharing by referring to the utilization data table 33 and the coefficient table 36, and gives the points to each user. After that, the point giving information is transmitted from the ride-sharing managing server 7 to each user terminal 2, and thus each user is notified of the number of points newly given thereto.

As described above, the points are given to each user who has utilized the ride-sharing, so that it is possible to give the user an incentive to utilize the ride-sharing, and thus to promote utilization of the ride-sharing.

The given value is calculated by summing the product of each item value (xⱼᵢ) and the coefficient A corresponding to each item regarding all the items. Accordingly, each item value can be easily converted to the points, and the given value can be calculated automatically and speedily. Further, the points are given in proportion to each item value, so that each user can easily understand the number of points to be given thereto and the feeling of unfairness about the given points can be reduced.

Further, as shown in FIG. 4, the coefficients A₁ to A₃ for the driver are larger than the corresponding coefficients A₄ to A₆ for the passenger, respectively. Accordingly, even if the riding distance of the driver and that of the passenger are identical to each other, the driver is given more points than the passenger who is not the driver. Accordingly, the number of users who desire to be drivers can be increased, and thus a trouble caused by the shortage of drivers can be suppressed.

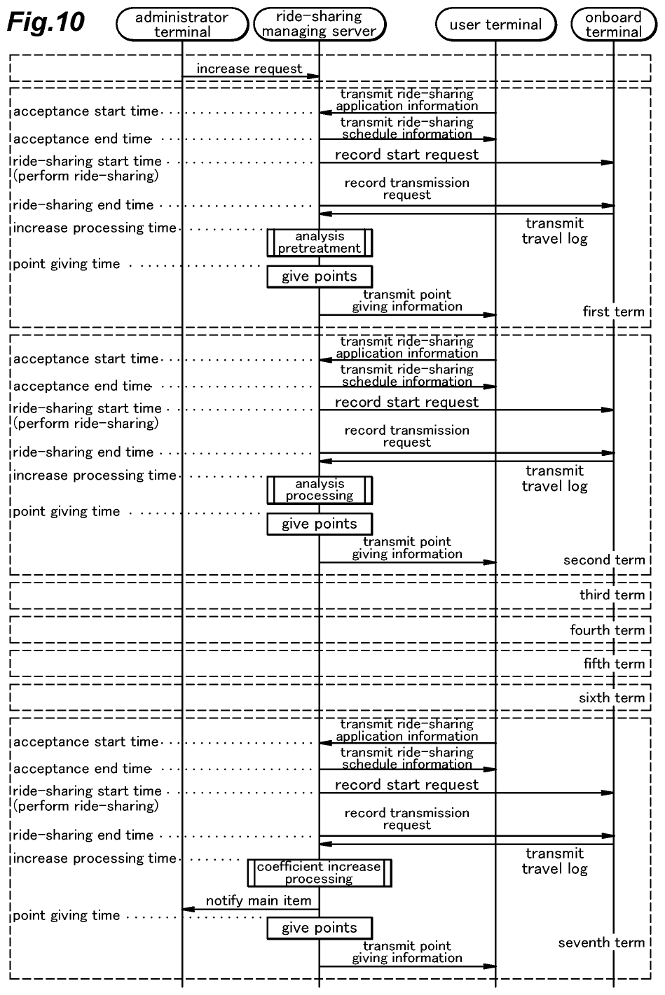

As shown in FIG. 10, upon receiving the increase request, the ride-sharing managing server 7 executes the increase processing. Upon receiving the increase request, the increase processing unit 27 executes the analysis pretreatment in the first term, and thus acquires the reference utilization rate ρ₀ (step ST11). After that, the increase processing unit 27 increases the coefficient A₁ of the first item by δA (step ST13). Next, the increase processing unit 27 calculates the changing amount of the utilization rate δρ₁ in the second term (step ST22), and acquires the changing rate r₁ of the first item (step ST23). After that, the increase processing unit 27 executes the analysis processing from the second term to the sixth term, and thus acquires the values of the changing rates r₂ to r₅ from the second item to the fifth item. At the end of the sixth term, the coefficients A₁ to A₅ of the first to fifth items are set to the values before the increase processing, and the value of the coefficient A₆ of the sixth item has increased by δA. In the seventh term, the increase processing unit 27 executes the coefficient increase processing. The increase processing unit 27 acquires the value of the changing rate r₆ of the sixth item in step ST32 of the coefficient increase processing. After that, the increase processing unit 27 updates the coefficient A_{L} of the L-th item with the largest changing rate to A_{L}+α. In the seventh term, the giving unit 25 gives the points to each user who has utilized the ride-sharing by using the updated coefficient A_{L}+α. The increase request is transmitted in the first term, and the points given to each user are increased in the seventh term. Namely, the increase request corresponds to a signal instructing the increase of the points given to each user.

The changing rate rᵢ (i=a number from 1 to M) corresponds to the improvement amount of the utilization rate when the points corresponding to the i-th item are increased by one unit. By using the changing rate rᵢ, the improvement amount of the utilization rate per unit point can be acquired for each item, so that the item with the largest improvement amount of the utilization rate (namely, the main item) can be evaluated appropriately when a certain number of points are given. By changing the coefficient corresponding to the main item, the utilization rate can be improved greatly when a certain number of points are given as compared with a case where the coefficient corresponding to the item other than the main item is changed. Accordingly, the points can be utilized more effectively in order to improve the utilization rate.

In the 7th term, the increase processing unit 27 updates the coefficient A_{L} of the L-th item (the main item) to A_{L}+α, and the giving unit 25 gives the points based on the updated coefficient table 36. At this time, the increase amount of the total points given to the group is substantially identical to ΔI. In this way, the numerical value α (see Equation 4), which is acquired by dividing the increase value ΔI by the total S_{L} of the item values of the main item for all the users who have performed the ride-sharing, is added to the coefficient A_{L} corresponding to the main item. Accordingly, the increase amount of the points given to the group can be substantially identical to the set value (the increase value ΔI).

Concrete embodiments of the present invention have been described in the foregoing, but the present invention should not be limited by the foregoing embodiments and various modifications and alterations are possible. In the above embodiment, the evaluation value acquiring unit 24 is configured to acquire the utilization rate as the evaluation value, but the evaluation value is not limited to the utilization rate. For example, after the ride-sharing, the evaluation value acquiring unit 24 may transmit a questionnaire regarding the satisfaction level of the ride-sharing to the user terminal 2 of each user who has utilized the ride-sharing, calculate an average value of the received satisfaction level of each user who has utilized the ride-sharing, and set the above average value as the evaluation value. Alternatively, the evaluation value acquiring unit 24 may calculate the total amount of CO₂ emitted from the shared vehicle 4 utilized for the ride-sharing based on the travel log and fuel efficiency of each shared vehicle 4, and set a difference between the calculated total amount of CO₂ and the total amount of emitted CO₂ (namely, CO₂ emitted when all the users who belong to the group each move to the workplace by driving the shared vehicle 4 with the highest fuel efficiency) as an evaluation value.

Each onboard terminal 5 may be configured to acquire the voice inside the vehicle by a microphone and to calculate a vehicle inside value indicating the quality of atmosphere inside the vehicle based on the above voice, and the evaluation value acquiring unit 24 may be configured to calculate the evaluation value based on the vehicle inside value. Alternatively, the onboard terminal 5 may be configured to acquire the acceleration of the vehicle and to calculate a driving skill value indicating the quality of driving skill based on the acceleration thereof, and the evaluation value acquiring unit 24 may be configured to calculate the evaluation value based on the driving skill value.

Further, in the above embodiment, the utilization data table 33 includes only the items related to the distances, but the present invention is not limited to this embodiment. For example, the utilization data table 33 may include at least two items except for the vehicle identification number and the user identification number, and may include items such as the boarding time, the number of times the ride-sharing is utilized, the date and time of the reservation, the number of times questionnaires are answered, the clean level and the fuel efficiency of the shared vehicle 4 utilized for the ride-sharing, and the driving skill of each user.

In the above embodiment, the increase processing unit 27 is configured to extract the main item and to allocate the increase value of the points only to the main item, but the present invention is not limited to this embodiment. For example, the increase processing unit 27 may be configured to allocate the increase value of the points to plural items in proportion to the changing amount of the utilization rate. By allocating the increase value to plural items in this way, it is possible to reduce the feeling of unfairness of each user that may be caused by increasing the points depending only on a specific item. Alternatively, the ride-sharing managing server 7 may be connected to a simulation server via the network 6, the simulation server may be configured to estimate a change in the utilization rate according to the allocation of the increase value of the points, and the ride-sharing managing server 7 may be configured to change an allocation method of the increase value according to the estimation result of the simulation server.

Further, δA is constant regardless of the items in the above embodiment, but the prescribed value may be set for each item. Further, the converted value is calculated by multiplying each item value by the coefficient in the above embodiment, but the present invention is not limited to this embodiment. For example, the converted value may be calculated by multiplying the square of each item value by the coefficient. Further, for example, the coefficient value may be set so as to depend on the evaluation value of the weather at a time when the ride-sharing is performed. At this time, the ride-sharing managing server 7 may be connected to a server configured to provide weather information via the Internet so as to acquire the evaluation value of the weather.

### GLOSSARY OF TERMS

1: vehicle ride-sharing assist system
22: ride-sharing operation managing unit
23: data acquiring unit
24: evaluation value acquiring unit
25: giving unit
26: coefficient storing unit
27: increase processing unit

1. A vehicle ride-sharing assist system utilized by a group including a plurality of members, comprising:
a ride-sharing operation managing unit configured to accept ride-sharing applications from the members for each prescribed period, to determine an operation schedule of at least one vehicle utilized for ride-sharing, and to notify the operation schedule to the members that have made the ride-sharing applications;
a data acquiring unit configured to acquire utilization data of each member that has performed the ride-sharing of the vehicle, the utilization data including item values respectively assigned to a plurality of items related to operation of the ride-sharing; and
a giving unit configured to convert each item value to a converted value for each member that has performed the ride-sharing in each prescribed period and to give each member a sum of the converted value as points.

2. The vehicle ride-sharing assist system according to claim 1, further comprising a coefficient storing unit configured to store a coefficient corresponding to each item,
wherein the converted value is converted by multiplying each item value by the coefficient corresponding to each item value.

3. The vehicle ride-sharing assist system according to claim 2, further comprising:
an evaluation value acquiring unit configured to acquire one evaluation value for all the ride-sharing performed by the group in each prescribed period; and
an increase processing unit configured to receive an increase request and an increase value, the increase request instructing an increase in a total of the points given to the members of the group,
wherein when receiving the increase request, the increase processing unit changes the coefficient of each item, acquires the evaluation value in the ride-sharing performed after the coefficient of each item is changed and thus acquires an improvement amount of the evaluation value per unit of the converted value of each item, extracts one of the items with a largest improvement amount per unit of the converted value as a main item, and executes increase processing to allocate a largest increase value to the main item.

4. The vehicle ride-sharing assist system according to claim 3, wherein in the increase processing, the increase processing unit acquires one value by dividing the increase value by a sum of the item value of the main item for all the members that have performed the ride-sharing, and adds the one value to the coefficient corresponding to the main item.

5. The vehicle ride-sharing assist system according to claim 1, wherein the data acquiring unit is configured to acquire driver information including information as to whether each member has served as a driver in the ride-sharing, and
in a case where one member has served as the driver in the ride-sharing, the giving unit gives the one member more points than in a case where the one member has not served as the driver.
